(19) United States
(12) Patent Application Publication
(10) Pub. No.: US 2026/0257450 A1
(43) Pub. Date: Sep. 3, 2026

(54) Damped Solid Body

(71) Applicant: KSB SE & Co. KGaA, Frankenthal (DE)

(72) Inventors: Boris JANJIC, Frankenthal (DE); Franz BOSBACH, Frankenthal (DE)

(21) Appl. No.: 18/870,865

(22) PCT Filed: May 26, 2023
(86) PCT No.: PCT/EP2023/064213

§ 371 Date: Dec. 2, 2024

(30) Foreign Application Priority Data
Jun. 3, 2022 (DE) 10 2022 001 932.9

(51) Int. Cl. B32B 3/28; B32B 5/16; F04D 7/02

(52) U.S. Cl. CPC B32B 3/28; B32B 5/16; F04D 7/02; B32B 2307/302; B32B 2307/56

(57) ABSTRACT

An arrangement for separating two media having an inner wall and an outer wall includes at least one space. The least one space that is formed between the inner wall and the outer wall. A material is integrated in the space.

### CROSS REFERENCE TO RELATED APPLICATION

This application claims priority under 35 U.S.C. §119 from German Patent Application No. 102022001932.9, filed Jun. 3, 2022, the entire disclosure of which is herein expressly incorporated by reference.

### BACKGROUND

The disclosure relates to an arrangement for separating two media having an inner wall and an outer wall, wherein at least one space is formed between the inner and outer walls.

The arrangement serves to separate two media, e.g. different fluids, during use in centrifugal pumps and/or in fittings.

Centrifugal pumps are based on the principle of action of energy transfer to a fluid by changing the angular momentum by means of a torque which is exerted by a uniformly rotating impeller on the fluid flowing through the latter. Centrifugal pumps generally have a spiral casing, in which a bladed impeller rotates at high speed.

A magnetic-coupling pump has such an arrangement for separating two media and is a centrifugal pump without a shaft seal in which the shaft torque of the drive is transmitted by magnetic forces using a permanent magnet coupling. The magnetic coupling consists of an outer rotor, which is connected rigidly to the motor shaft, and an inner rotor connected to the pump shaft. Both rotors are fitted with permanent magnets, such that opposite poles lie opposite one another. If the outer rotor is driven, the inner rotor moves in synchronism and thus rotates the impeller of the pump. Complete sealing is achieved by the installation of an arrangement for separation, referred to as a can, in the gap between the outer and the inner rotor.

The use of a can between the primary and the secondary part ensures sealing between these components, and therefore liquids or indeed gases, for example, cannot flow from the secondary side in the direction of the primary side. This is decisive particularly if the magnetic coupling is used in a pump, for example. In this case, the impeller of the pump is arranged together with the secondary part of the magnetic coupling on a common shaft, while the primary part is connected to a motor shaft. Depending on the pumping medium of the pump, a situation where this medium flows through the can in the direction of the primary part or in the direction of the motor must then be avoided.

Faults or malfunctions have the effect, on the one hand, that the primary part and/or the secondary part may directly damage the can and, on the other hand, that damage to the can may be caused directly by magnetic or non-magnetic solids in the pumping medium. However, this damage can be detected only with difficulty during operation. For this reason, double-wall cans have proven to be valuable in practice, wherein a gap is arranged between the walls, and this gap is monitored continuously by means of monitoring sensors, and thus damage to the can can be detected.

WO 2020/212250 A1 discloses a can for a magnetic coupling having a cylindrical lateral surface region and a base region adjoining a first end of the lateral surface region, wherein at least the lateral surface region has an inner wall and an outer wall surrounding the inner wall, wherein the inner wall and the outer wall are spaced apart from each other in the radial direction by a gap. According to the disclosure, the inner wall is integrally connected to the outer wall via a plurality of webs. According to the disclosure, it is possible to determine the leakage of the can by monitoring the inner gap by means of a control medium.

A fitting refers to a component for varying and controlling substance flows, which is used, in particular, on pipes and containers for fluids.

A bellows refers to a flexible tube which can fold up “in the manner of an accordion” and is mounted for protection over machine components that slide mechanically one inside the other in order to protect them from external influences, in particular contamination, and to seal them off from the environment.

In the case of valves for use in the chemical industry, bellows are used for hermetically sealing moving valve components with respect to stationary components.

The manufacture of arrangements for separating two media by an additive manufacturing method is already known. In the case of additive manufacturing methods, a component is produced by adding material. One special feature of generative manufacturing methods is that the manufacturing process takes place without tools and without molds directly on the basis of 3D CAD data. This increases the flexibility of manufacture in comparison with conventional manufacturing methods. Moreover, particularly delicate and also complex components can be produced.

However, the disadvantage with components which are manufactured additively is that they exhibit significantly less damping and significantly lower heat conduction relative to components which have been produced by conventional manufacturing methods.

Moreover, additional safeguarding of safety-relevant components is required by a new European safety directive.

### SUMMARY

It is the object of the disclosure to provide an arrangement for separating two media which is distinguished by improved damping and improved heat conduction. In addition, the arrangement should be capable of separating two media in accordance with current safety requirements. Moreover, the arrangement should be distinguished by a compact design. It should be possible to implement the arrangement in a simple and low-cost manner.

This object is achieved according to the disclosure by an arrangement for separating two media. Preferred variants can be found in the additional main claims, the dependent claims, the description and the drawings.

According to the disclosure, a material is integrated in the space.

A space is defined by the three mutually orthogonal dimensions of length, width and height. By means of its walls, it delimits a volume and thus forms a geometrical body.

At least one space of the arrangement is formed between the inner and outer walls. In the simplest embodiment of the disclosure, there is just one space between the walls of the arrangement. This space can extend over the full area between the walls or, alternatively, only in a small region of the walls.

As an alternative, it is also possible for two and/or more and/or a multiplicity of spaces extending adjacent to one another and/or in parallel to extend between the walls of the arrangements. These spaces can have connections or can be configured in a manner free from connections. Such connections can preferably be in the form of a passage, for example.

Material in the narrower sense of engineering materials refers to substances in the solid state of aggregation from which components and structures can be produced.

The material can preferably be in the form of pellets or powder or granules or particles.

Ideally, the material is a pourable material. To this end, the material can be in the form of a pourable bulk material or fine material.

Pourability refers to the capacity of bulk materials or fine materials to flow vertically under defined conditions. The pourability of a bulk material is determined by its composition and the characteristics of its particles. Examples of influencing variables are particle size, particle size distribution, surface characteristics of the particles and the adhering moisture.

Pourability is often stated as the time for a specified sample quantity to run out of defined funnels. The corresponding procedures are standardized: ISO 6186 defines the pouring time as the runout time in seconds. ISO 4490, ASTM B213, ASTM B855 and ASTM B964 define pourability as the runout time in seconds or s/20 cm³.

In an advantageous variant of the disclosure, the material is in the form of agglomerated particles.

Ideally, the space is filled with at least 10%, preferably with at least 20%, in particular with at least 30%, of material and is filled with less than 90%, preferably less than 80%, in particular with less than 70%, of material.

“Integrated” refers to combining something into a higher-level whole. In this context, the material is incorporated into a higher-level whole of the arrangement for separating two fluids.

Ideally, the material is incorporated and/or included and/or inserted into a greater whole, in particular into the space of the arrangement.

The material is preferably integrated in a form-fitting manner into at least one space of the arrangement. This form-fitting integration comes about through the fitting of the material into the space. As a result, the material cannot leave the space. Moreover, it would also be impossible for the material to be retrofitted into the space.

The material is advantageously introduced in a captive manner into the space. This means that the material can neither be retrofitted nor can the material be removed from the space.

In a particularly preferred variant of the disclosure, the material in the space and the material of the walls is made of the same material, in particular of identical design. The walls of the space and the material itself thus consist of a homogeneous substance.

The inner wall is preferably formed integrally with the outer wall. As a result, the arrangement for separating two fluids is also of fully integral design.

In a particularly advantageous variant of the disclosure, at least one sensor is arranged in the space.

Such a sensor can be in the form of a monitoring sensor which is designed in such a way that it can detect damage to the inner and/or outer wall. The sensor can preferably detect the dew point, the temperature, the oxygen content, the pressure and/or the conductivity in the space and/or of a control medium in the space.

If the dew point is monitored, the monitoring sensor is a dew point sensor, which continuously monitors the dew point of a liquid control medium. If a wall is damaged, a fluid can penetrate into the space and mix with the control medium. This leads to a change in the dew point.

Alternatively, the space can be filled with a gaseous control medium, e.g. argon or some other noble gas, wherein the sensor is embodied as an oxygen sensor. If, for example, an oxygen-containing fluid penetrates into the space, the oxygen content changes, and the sensor signal can be used to generate a warning message.

Irrespective of the design of the sensor, the control medium is preferably a non-reactive fluid.

The advantageous monitoring of the space by means of at least one sensor represents an additional safeguard for the operation of safety-relevant components. Given appropriate integration of the sensor into a higher-level monitoring system or process management system, the requirement for a “second line of defense” in current safety directives can be taken into account without having to additionally encapsulate the safety-relevant components.

In another variant embodiment, the space is of fluid-free and/or gas-free design. Alternatively, the space can also have a vacuum.

In the embodiment of the arrangement as a can or as a bellows, the space can extend in the circumferential direction of the arrangement.

In an advantageous embodiment of the disclosure, separating webs are arranged between the inner and the outer wall in the circumferential direction and extend in the longitudinal direction. In this context, the longitudinal direction refers to the direction which is oriented parallel to the lateral surface region of the arrangement. The number and spacing of the webs can be, for example, the result of mechanical and thermal optimization to reduce eddy current losses.

However, the disclosure also comprises further alternative variant embodiments of the separating webs. Thus, for example, a spiral configuration, an arcuate embodiment or penetration of spaces arranged longitudinally and in the circumferential direction are also possible. In addition, the individual alternatives can also be combined with one another. By using separating webs extending in the longitudinal direction, on the one hand, and separating webs extending in the circumferential direction, on the other hand, it is possible to achieve a grid-shaped arrangement of webs in the space.

In a particularly advantageous variant of the disclosure, the material is integrated in the space, while the space is formed by an integral wall. This preferably takes place during the generative manufacture of the arrangement. In this case, the space is formed from a powdered material during selective laser melting or a powder bed method by selective melting on of the powder. In this case, however, in contrast to the otherwise painstaking removal of excess powder, this excess powder is just left in place. As a result, the excess material in the space is enclosed integratively as the space is formed.

According to the disclosure, in the method for producing an arrangement, the material is integrated into the space, while the inner and outer walls are produced by the selective action of radiation on the material.

Ideally, the arrangement for separating two fluids is manufactured generatively. By means of additive manufacture, it is possible to implement the complex design of the arrangement with material integrated in the space. In addition, it is also possible to manufacture specifically tailored individual examples of the arrangement according to requirements and extremely quickly.

An arrangement for separating two fluids has been produced by an additive manufacturing method. The term “additive manufacturing method” comprises all manufacturing methods in which material is applied layer by layer and, in this way, three-dimensional integral walls and at least one space are produced. In this case, the layer by layer buildup takes place under computer control from one or more liquid or solid engineering materials according to predetermined dimensions and shapes. During the buildup, physical or chemical curing or melting processes take place. Typical engineering materials for 3D printing are plastics, synthetic resins, ceramics, metals, carbon materials and graphite materials.

Methods used to form the arrangement include, in particular, selective laser melting and cladding, also known as deposition welding. In an alternative variant of the disclosure, extrusion in combination with the application of meltable plastic is also a method that can be used.

In selective laser melting, the arrangement for separating two fluids is produced by a method in which a layer of a buildup material is first of all applied as a substrate. The buildup material for the production of the arrangement preferably comprises metallic powder particles. In one variant of the disclosure, ferrous and/or cobalt-containing powder particles are used for this purpose. These can contain additives such as chromium, molybdenum or nickel. The metallic buildup material is applied in powder form in a thin layer to a plate. The powdered engineering material is then completely melted locally at the respectively desired points by means of radiation and, after solidification, a solid layer of material is formed. The substrate is then lowered by the amount of a layer thickness and more powder is applied. This cycle is repeated until all the layers have been produced and the finished arrangement has formed. Here, the excess powder remains in the space of the arrangement, thereby making it possible to achieve novel special characteristics of the arrangement.

As radiation it is possible, for example, to use a laser beam, which generates the arrangement from the individual powder layers. The data for guiding the laser beam are generated by means of software on the basis of a 3D CAD body. As an alternative to selective laser melting, it is also possible to use an electron beam (EBN).

In deposition welding or cladding, the arrangement is produced by a method which coats a starting piece by welding. In deposition welding, a volume which provides a particularly delicate and optimized shape of the arrangement is built up by means of a welding filler in the form of a wire or a powder.

The material integrated in the space which is formed between the inner and outer walls of the arrangement ensures special properties that are important for the technical application. By way of example, the arrangement has significantly improved thermal conductivity by virtue of the integration of the material in the space. As a result, it is possible to more effectively dissipate the heat generated by eddy current losses when the arrangement is used as a can in centrifugal pumps with magnetic couplings.

However, the material-filled space of the arrangement also leads to increased damping of the component, which is very close to the damping provided by gray cast iron. As a result, vibration which occurs, for example, during the operation of a centrifugal pump can be absorbed in an outstanding manner.

The arrangement for separating two fluids furthermore also has improved pressure resistance that can be achieved by means of the material-filled space.

Moreover, removal of the material can be eliminated by the material remaining in the space of the arrangement. For this purpose, the component must normally be removed from the additive manufacturing machine and cleaned by hand. This leads to an increase in the speed of manufacture.

Integrating the material into the space of the arrangement for separating two fluids leads to an advantageous improvement in the mechanical and thermal characteristics while simultaneously increasing the speed of manufacture.

The arrangement for separating two fluids having an inner and an outer wall, which forms a space into which a material is integrated, is used to improve the damping and/or improve heat conduction in static fluid separation devices, in particular in the case of cans of centrifugal pumps, and also in the case of bellows of fittings.

In addition, the arrangement of a sensor or of a plurality of sensors which monitor the ability to function of the arrangement offers an additional safeguard of the kind required by modern safety regulations. The monitored space of the arrangement thus offers a “second line of defense” and avoids a second enclosure for cans or bellows.

Additional features and advantages of the disclosure will become apparent from the description of exemplary embodiments with reference to the drawings and from the drawings themselves.

In the drawings:

### BRIEF DESCRIPTION OF THE DRAWINGS

FIG. 1 shows a section through a magnetic-coupling pump,

FIG. 2 shows a section through a bellows-type fitting,

FIG. 3 shows a detail of a space according to the disclosure,

FIG. 4 shows another variant embodiment of the space,

FIG. 5 shows an alternative embodiment of the space.

### DETAILED DESCRIPTION

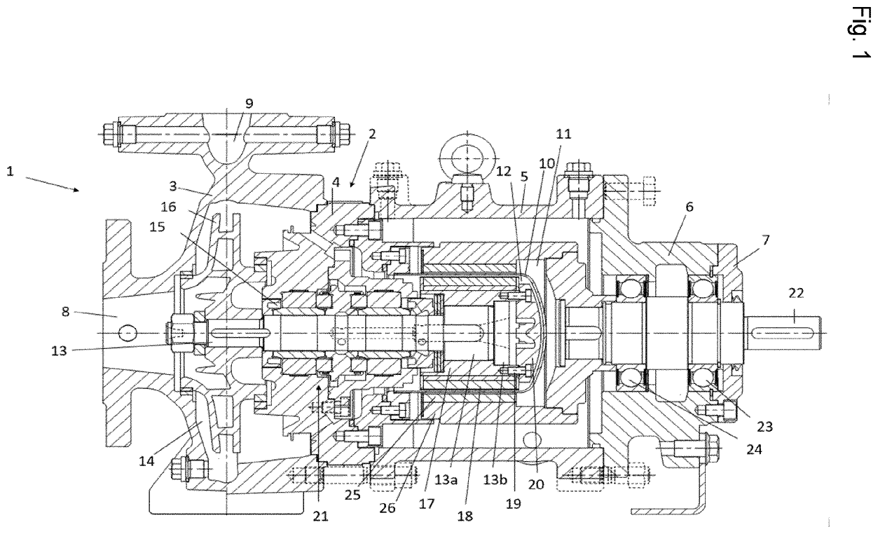

FIG. 1 shows a pump 1 in the form of a magnetic-coupling pump. The pump 1 has a multi-part pump casing 2 of a centrifugal pump, which comprises a hydraulic casing 3 designed as a spiral casing, a casing cover 4, a bearing support bracket 5, a bearing support 6 and a bearing cover 7.

The hydraulic casing 3 has an inlet opening 8 for taking in a pumping medium and an outlet opening 9 for discharging the pumping medium. The casing cover 4 is arranged on the opposite side of the hydraulic casing 3 from the inlet opening 8. The bearing support bracket 5 is secured on the side of the casing cover 4 which faces away from the hydraulic casing 3. The bearing support 6 is mounted on the opposite side of the bearing support bracket 5 from the casing cover 4. The bearing cover 7, in turn, is secured on the side of the bearing support 6 which faces away from the bearing support bracket 5.

An arrangement for separating two fluids 10, which is embodied as a can in the variant embodiment illustrated, is secured on the side of the casing cover 4 which faces away from the hydraulic casing 3, and it extends at least partially through an interior 11 delimited by the pump casing 2, in particular by the casing cover 4, by the bearing support bracket 5 and by the bearing support 6. The arrangement 10 hermetically seals a chamber 12 surrounded by the arrangement and the casing cover 4 with respect to the interior 11.

A rotatable impeller shaft 13 extends from a flow chamber 14, which is delimited by means of the hydraulic casing 3 and the casing cover 4, through an opening 15 provided in the casing cover 4 into the chamber 12. Secured on a shaft end of the impeller shaft 13 which lies within the flow chamber 14 is an impeller 16, and an inner rotor 17, which is arranged within the chamber 12, is arranged at the opposite shaft end, which has two shaft sections 13a, 13b with respectively increasing diameters. The inner rotor 17 is fitted with a plurality of magnets 18, which are arranged on the side of the inner rotor 17 which faces the can 10. An auxiliary impeller 20 is secured on the inner rotor 17 by means of screws 19 or other suitable fastening means.

A bearing arrangement 21 operatively connected to the rotatably drivable impeller shaft 13 is arranged between the impeller 16 and the inner rotor 17.

A drive motor (not shown), preferably an electric motor, drives a drive shaft 22. The drivable drive shaft 22 is arranged substantially coaxially with the impeller shaft 13. The drive shaft 22 extends through the bearing cover 7, the bearing support 6 and at least partially into the bearing support bracket 5. The drive shaft 22 is mounted in two ball bearings 23, 24 accommodated in the bearing support 6. An outer rotor 26 carrying a plurality of magnets 25 is arranged at the free end of the drive shaft 22. The magnets 25 are arranged on the side of the outer rotor 26 which faces the arrangement 10. The outer rotor 26 extends at least partially via the arrangement 10 and interacts with the inner rotor 17, such that, by means of magnetic forces, the rotating outer rotor 26 likewise imparts a rotary motion to the inner rotor 17 and thus to the impeller shaft 13 and the impeller 16.

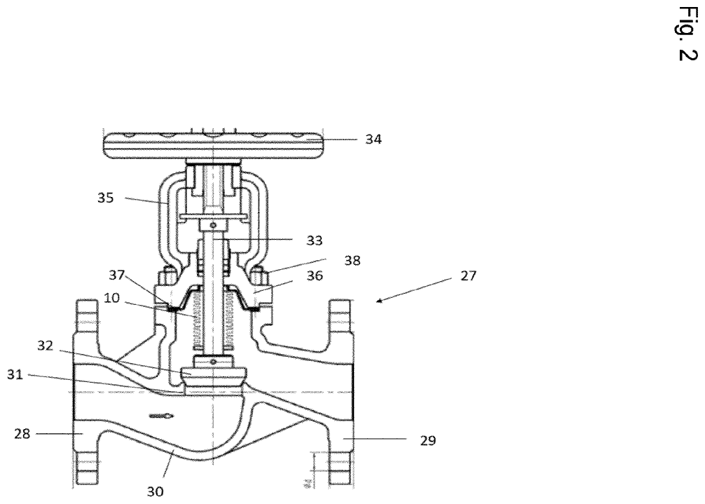

FIG. 2 shows a section through a bellows-type fitting in the embodiment as a bellows-type valve 27. The fluid flows through the valve body 30 from the inlet flange 28 in the direction of the outlet flange 29. The hemispherical valve member 32 can enter into a sealing operative relationship with the valve seat to shut off the movement of fluid. In this case, the hemispherical valve member 32 is connected for conjoint rotation to the valve spindle 33, which can be moved by means of the valve superstructure 35 via the hand wheel 34.

The passage of the valve spindle 35 through the valve structure 36 is sealed off by means of the arrangement 10 for separating two fluids. In the variant embodiment illustrated, the arrangement 10 for separation is embodied as a bellows. The valve structure 36 is connected to the valve body 30 by the fixing elements 38 and sealed off against the escape of fluid by means of the sealing element 37.

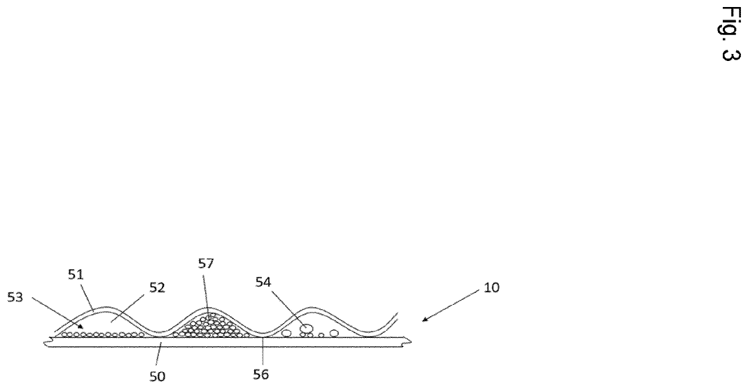

FIG. 3 shows a detail of a space 52 according to the disclosure as a segment of an arrangement 10 for separating two fluids. The segment illustrated shows three different configurations of the space 52. The space 52 is formed by the inner wall 50 and the outer wall 51, wherein the outer wall 51 has a sinusoidal profile.

The separating webs 56 are arranged between the inner wall 50 and the outer wall 51 in the circumferential direction and extend in the longitudinal direction. In this context, the longitudinal direction means the direction which is oriented parallel to the lateral surface region of the arrangement 10. As a result, the space 52 extends in a spiral shape with a shallow slope in the circumferential direction of the arrangement 10.

A material 53 is integrated in the space 52. The material 53 is in the form of a pourable powder which has remained in the space during the integral formation of the inner wall 50 and the outer wall 51 by means of selective laser melting. The material 53 and the inner wall 50 as well as the outer wall 51 consist of the same engineering material.

To achieve a particularly high thermal conductivity and a particularly high damping effect, the space 52 can be filled with a complete fill 57 of the material 53. The complete fill 57 corresponds to filling by up to 90%.

In another variant embodiment, the space 52 can also be filled with agglomerated particles 54.

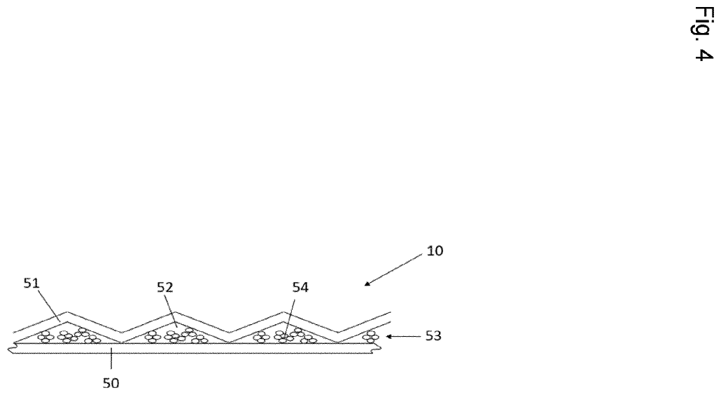

FIG. 4 shows another segment of the arrangement 10 in a variant embodiment of the space 52. FIG. 4 corresponds largely to FIG. 3. In this figure, the outer wall 51 has a trapezoidal profile, and therefore the space 52 has a triangular cross section. The material 53, which is in the form of agglomerated particles 54 in FIG. 4, is integrated in the space 52.

The material 53 has remained in the space 52 during additive production and has not been painstakingly removed as is otherwise customary. In the variant illustrated, some particles of the material 53 have been formed into agglomerated particles 54 by means of the energy input in order to achieve desired characteristics in respect of heat conduction and damping. The material 53 is thus integrated in a form-fitting manner in the space 52 and it would also not be possible for it to be retrofitted.

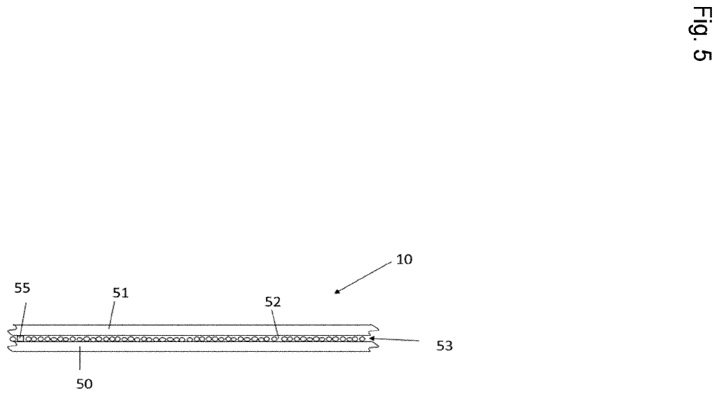

FIG. 5 shows an alternative configuration of the space 52 in an illustration of a segment of the arrangement 10. In this figure, the outer wall 51 is particularly flat and embodied without any raised portion and without separating webs 56. The material 53 is integrated in the space 52 as a pourable fill. In addition, the space 52 has a sensor 55, which is embodied as a conductivity sensor in this variant embodiment. It is thereby possible to continuously monitor the integrity of the arrangement 10. In the event of damage, an evaluation unit coupled to the sensor can trigger an alarm.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-13. (canceled)

14. An arrangement for separating two media having an inner wall and an outer wall, comprising:
at least one space that is formed between the inner wall and the outer wall, wherein
a material is integrated in the space.

15. The arrangement as claimed in claim 14, wherein the material is configured as a pourable material.

16. The arrangement as claimed in claim 15, wherein the material in the space and the material of the inner wall and the outer wall is made of the same material.

17. The arrangement as claimed in claim 16, wherein the inner wall is formed integrally with the outer wall.

18. The arrangement as claimed in claim 17, wherein material is integrated in the space, and the space is formed by an integral wall.

19. The arrangement as claimed in claim 18, wherein the material is integrated in a form-fitting manner in the space.

20. The arrangement as claimed in claim 19, wherein the material is agglomerated particles.

21. The arrangement as claimed in claim 20, wherein the space is filled with at least 30%, of material and/or is filled with less than 70%, of material.

22. The arrangement as claimed in claim 21, wherein at least one sensor is arranged in the space.

23. The arrangement as claimed in claim 22, wherein the space is of fluid-free and/or gas-free design.

24. The arrangement as claimed in claim 23, wherein the space extends in a circumferential direction of the arrangement.

25. A method for producing an arrangement, comprising:
integrating material into a space, while inner and outer walls are produced by selective action of radiation on the material.

26. A method comprising:
using the arrangement of claim 24 for improving damping and/or for improving heat conduction.

27. An arrangement for separating two media in centrifugal pumps and/or in fittings having an inner wall and an outer wall, comprising:
at least one space that is formed between the inner wall and the outer wall of the centrifugal pumps and/or in fittings, wherein
a material is integrated in the space.

28. The arrangement as claimed in claim 27, wherein the material is configured as a pourable material.

29. The arrangement as claimed in claim 28, wherein the material in the space and the material of the inner wall and the outer wall is made of the same material.

30. The arrangement as claimed in claim 29, wherein the inner wall is formed integrally with the outer wall.

31. The arrangement as claimed in claim 30, wherein material is integrated in the space, and the space is formed by an integral wall.

32. The arrangement as claimed in claim 31, wherein the material is integrated in a form-fitting manner in the space.

33. The arrangement as claimed in claim 32, wherein the material is agglomerated particles.
